(19) United States
(12) Patent Application Publication
(10) Pub. No.: US 2002/0109989 A1
(43) Pub. Date: Aug. 15, 2002

(54) Solid joint structure of christmas lamp

(76) Inventor: Te-Chun Chuang, Hsinchu (TW)

Correspondence Address: RABIN & CHAMPAGNE, PC, 1101 14TH STREET, NW, SUITE 500, WASHINGTON, DC, 20005, US

(21) Appl. No.: 09/732,779

(22) Filed: Dec. 11, 2000

(51) Int. Cl. H01R 33/00

(52) U.S. Cl. 362/226; 362/806

(57) ABSTRACT

This invention provides a design of solid joint structure of luminous LED Christmas lamp. The luminous LED, jointed with the fixed location of the outer cover and always covered inside of the outer cover, is fixed with the lamp bottom, and so does the outer cover. This invention has characteristics of fireproofed safety feature, and low production cost with fine quality.

### FILED OF THE INVENTION

This invention is related to a type of Christmas lamp, particularly related to the solid joint structure of luminous LED Christmas lamp. The fireproof protective casing provides safety feature to luminous LED and the protective casing is easy to make with low cost and fine quality. That makes the invention more acceptable to users and more market potential.

### BACKGROUND OF THE INVENTION

In the traditional Christmas lamp there are one lamp bottom jointed with one shell base, one LED cover jointed with the lamp bottom, and one guide wire of the LED lamp tightened and fixed with the power supply. However the bared LED lamp is flammable material without any protection. The Christmas LED lamp is a kind of ornaments for the holidays and often fit with other decorations or ornaments. When it is circuited, and keeps changing switch on/off status rapidly and frequently in a long time, it is very likely to produce a spark in the electric circuit and produce flame propagation in external environment. As the previous description, the LED lamp is a bare and flammable ornaments lamp and has the side effects of dry and inflammation in long hour continuous use. That is why it is required to have safety inspection for Christmas lamp especially the safety of fire protection.

Please refer to FIG. 1. Therefore there is a type of Christmas lamp which has the outer cover (11), made of PC material, directly casing in the external perimeter of the lamp bottom (12), and covering the whole LED lamp. The PC material makes the outer cover (11) light transmission, and high-temperature resistance. It also prevents the LED lamp (12) tough with other subjects. The design meets the safety inspection and the requirement of fire protection. However the PC-made outer cover (11) is high production cost and easy to fall apart as it simply just joints with the lamp bottom (13). The outer cover (11) is hardly jointed, especially by the influences of varies temperature and humidity of different area. The outer cover (11) and the lamp bottom (13) are easy to fall apart, and so it has no function of fireproof. Similar to traditional Christmas lamps, their LED lamp (12) is bare and flammable near other flammable materials. This dangerous side effect of inflammation really needs manufactories to seek for improvements.

### SUMMARY OF THE INVENTION

The creator of this invention has many years of experiences in producing and designing of light bulbs and Christmas lamps. He knows the fire safety problem of the Christmas lamp, and seeks low-in-cost and fine- in-quality solution. By doing creative innovation and continuous research, he has invented this novel creation.

That is the solid joint structure of luminous LED Christmas lamp. The primary objective is to achieve fireproof and light transmission feature of the solid joint structure of the outer cover to joint with the luminous LED and casing with the lamp bottom. The luminous LED is not bare lamp but always covered by the outer cover therefore the luminous LED has fire protection feature.

The second objective of this design of the solid joint structure of luminous LED Christmas lamp is to joint the luminous LED with outer cover and casing the outer cover with the locating lamp bottom. The outer cover can be made by waster material and has advantages of low cost of production and fine quality.

In order to help the committees easily understand the purpose, special feature, efficiency of this invention and explain further detail of this invention. Here is a better practical example for this application and some drawings to represent the details.

### BRIEF DESCRIPTION OF THE DRAWINGS

FIG. 1 is the traditional Christmas lamp with PC-made outer cover.

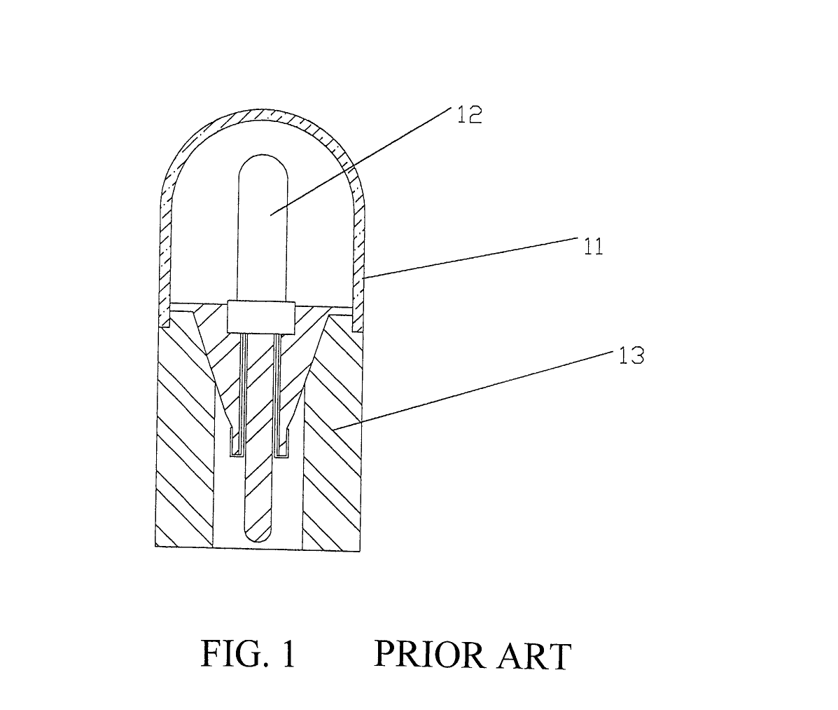

FIG. 2 is the lamp bottom and the outer cover of the Christmas lamp of this invention.

FIG. 3 and FIG. 4 are the section representation diagram for the parts of the lamp bottom and the outer cover of this invention. The Specification of Numbered Description of Drawing:

| | | | |
|---|---|---|---|
| lamp bottom | (20) | socket hole | (21) |
| locating pillar | (22) | pore | (23) |
| shell base | (24) | hollow groove | (25) |
| outer cover | (30) | middle hole | (31) |
| contraction face | (32) | inner race | (33) |
| luminous LED | (40) | base | (41) |
| locating groove | (42) | guide wire | (43) |

### DETAILED DESCRIPTION OF THE INVENTION

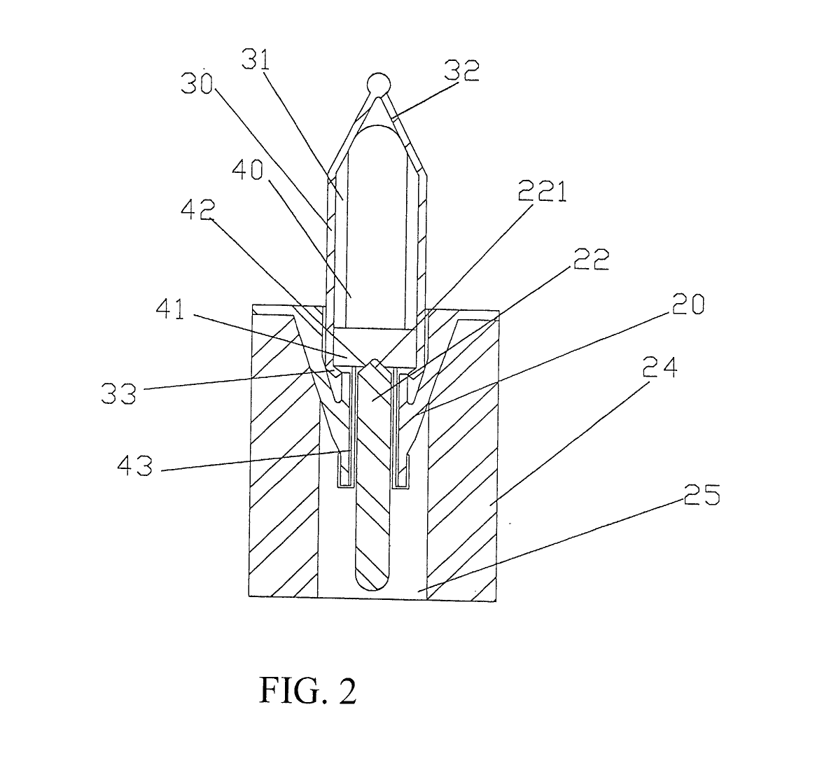

Please refer to FIG. 2. That is the better practical application of this invention of solid joint structure of luminous LED Christmas lamp. There are one lamp bottom (20), one outer cover (30) and one luminous LED (40) to form the invention. In which:

The lamp bottom (20) (Please refer to FIG. 2) is the structure molded by engineering plastic, and there is a concave shape of joint ring (21) in the apex. There is an extended uplifted locating pillar with appropriate length in the center of the bottom of the joint ring (21). The sides of the locating pillar form one apex, and the bottom circumferences of the joint ring (21) has 2 holes (23); the shell base has one hollow groove for the lamp bottom (20) to joint with the locating pillar.

The outer cover (30) is made of glass material and molded as a hollow-center shell shape. Glass is a good material for light transmission, high-temperature resistance, and fireproof characteristic. The outer cover forms a middle hole with appropriate shell thickness, and its apex form a contraction face. The inner bottom ring of the middle hole forms an inner convex-inside ring (33).

The luminous LED (40), which is covered inside of the middle hole of the outer cover using the LED lamp cover, has a base (41) in the bottom. That base is slightly larger than the external circumference. The external circumference of the base (41) is smaller than the middle hole (31), and larger than the circumference of the inner ring. The center of the bottom face of the base (41) has one inner concave locating groove (42) and two guide wires (43) outside of the bottom perimeter.

Please refer to FIG. 2 to FIG. 4. From the above descriptions of the structure, we know that firstly the luminous LED (40) is placed inside of the middle hole (31) of the outer cover (30) and then heat up the outer cover (30) to make the bottom of the inner circumference of the middle hole (31) form an inner concave ring (33). The inner circumference of this inner ring (33) is slightly smaller than the external circumference of the base (41). The luminous LED (40) is covered inside of the middle hole (31) of the outer cover (30) and fixed in a restrained position. That luminous LED (40) will not be fall off from the outer cover.

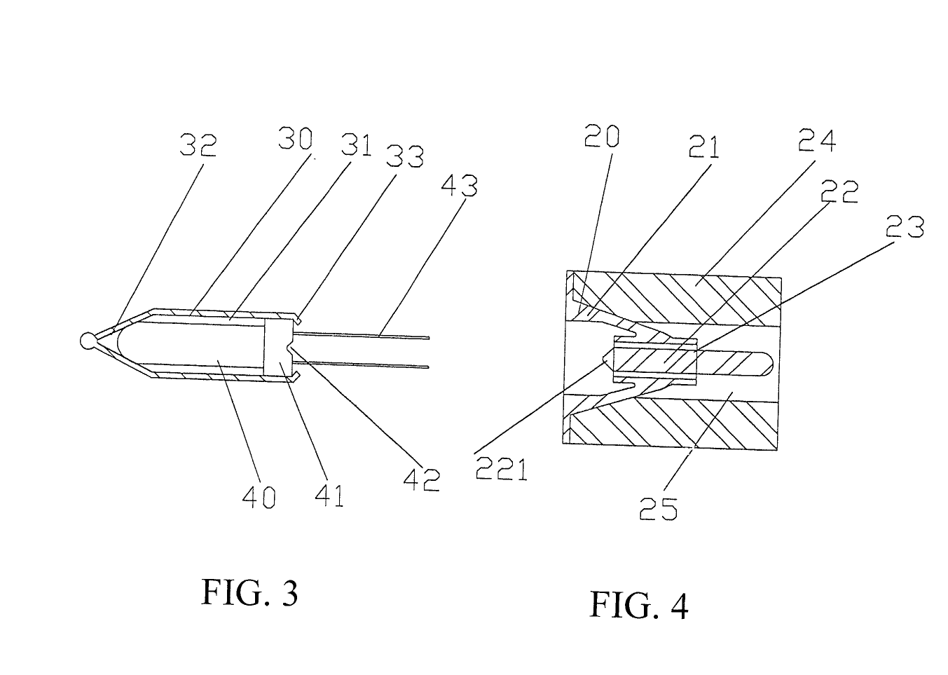

Please refer to FIG. 3 and FIG. 4. While in the assembly procedure, the outer cover (30) is jointed with the joint ring (21) of the lamp bottom (20), and the locating pillar in the center of the bottom of the joint ring (21) is extended upwards. The apex of the locating pillar can support the locating groove (42), which is located in the center bottom of the base (41). The base (41) is supported by the apex, and the luminous LED (40) can be moved up, and its apex is closed to the contraction face of the middle hole (31). The luminous LED (40) can be stably placed to the fixed position with the contraction face as it has reducing shape aspect. The apex of the locating pillar (22) can support the locating groove (42), and it makes the luminous LED (40) position vertically and stably fixed inside of the middle hole 931) of the outer cover (30). The guide wire (43) of the luminous LED (40) can pass through the hole (23) of the joint ring (21), and form a curve shape to tighten with the lamp bottom (20).

From the above description, it is clear to understand that the outer cover is jointed with the joint ring of the lamp bottom; the colloids is injected into the joint ring; the outer cover is fixed firmly and sealed with the lamp bottom; the luminous LED is joint in the middle hole of the outer cover to form a solid joint structure; the guide wire (43) of the luminous LED (40) is tighten with the lamp bottom (20); the luminous LED (40) is fixed firmly with the lamp bottom (20) and covered inside of the outer cover (30); the luminous LED (40) is not bare but covered to prevent direct tough to users' bodies or any other flammable decoration and ornaments; the luminous LED has good safety feature; the outer cover, made of glass, has good light transmission and high-temperature-resistance and fireproof characteristic; the luminous LED (40) of the Christmas lamp has good isolation to high-temperature and fire that meets the requirement of regulation for fire safety inspection.

The outer cover (30) is made of glass, and can be produced with automatic mass and fast production mechanical procedures. The glass material is original from the recycle and recovery of the waste material of the light bulb. The cost of the glass material is cheap in price and the glass material can be produced in large quantity. The cost of the glass material is far lower than the cost of PC material. Moreover the new product, made of glass, has good fireproof safety feature and it is low in cost with fine quality. That is very competitive in the market. The more important point is that the luminous LED of this invention is jointed with the fireproof and light-transmission outer cover; the inner ring (33) of the outer cover (30) is slightly smaller than the external circumference of the base (41); the luminous LED (40) is fixed in the middle hole (31) and formed a restrain fixed position; the luminous LED (40), fixed inside of the outer cover (30), will not be fall off; the outer cover (30) is jointed with the lamp bottom (20); the luminous LED (40) will never be bare and separated from the outer cover, the invention has very good fireproof safety feature.

To conclude from the above, this invention of solid joint structure of luminous LED of Christmas lamp solid joint the luminous LED with the outer cover and joint with the lamp bottom. The luminous LED is not bare but covered inside of the outer cover and has good fireproof safety feature. The outer cover can be made of water material with low cost in production and fine quality. This invention has industrial utility, originality of the creation and novelty, and meets the requirements of patent for novelty.

I Claim

1. The structure of the solid joint structure of the luminous LED of the Christmas lamp generally includes:
One lamp bottom: which is jointed with one shell base and has a joint ring on the top. There is a locating pillar extended upwards with appropriate length in the joint ring.
One outer cover: which is made of light-transmission and high-temperature-resistance material. It is jointed to the joint ring of the lamp bottom. The outer cover has a middle hole, and the apex of the middle hole is a contraction face and the bottom is the inner ring.
One luminous LED: which is jointed to the middle hole of the outer cover. Its bottom forms a base; the external circumference of its base is smaller than the middle hole but larger than the circumference of the inner ring.
From the above description of the structure, the outer cover is jointed to the joint ring of the lamp bottom. The luminous LED pivots to the fixed joint ring of the lamp bottom. The luminous LED is jointed to the middle hole and forms a solid joint structure. This structure has a locating pillar to support the base of the luminous LED and the apex of the luminous LED is attached to the contraction face of the middle hole.

2. The structure According to claim 1, in which, the outer cover is molded and made of glass, which provides heat resistance and fireproof characteristic.

3. The structure According to claim 1, in which, the base of the luminous LED has a locating groove which is attached with a locating pillar to form a up-down supportive luminous LED.

4. The structure According to claim 2, in which, the base of the luminous LED has a locating groove which is attached with a locating pillar to form a up-down supportive luminous LED.
